(19) United States
(12) Patent Application Publication
(10) Pub. No.: US 2026/0129737 A1
(43) Pub. Date: May 7, 2026

(54) DEVICE AND METHOD FOR LIGHTING CONTROL

(71) Applicant: SIGNIFY HOLDING B.V., EINDHOVEN (NL)

(72) Inventors: ANOOP KUMAR, NOIDA (IN); PARAS DAGAR, NOIDA (IN); RAVINDER JANGRA, NOIDA (IN); KARAN NASSA, NOIDA (IN)

(21) Appl. No.: 19/116,534

(22) PCT Filed: Sep. 29, 2023
(86) PCT No.: PCT/EP2023/076998

§ 371 Date: Mar. 28, 2025

(30) Foreign Application Priority Data
Sep. 30, 2022 (IN) 202241056286
Nov. 29, 2022 (EP) 22210124.8

(51) Int. Cl. H05B 47/19; H05B 47/175

(52) U.S. Cl. CPC H05B 47/19; H05B 47/1965

(57) ABSTRACT

A device (102) for lighting automation includes at least one communication interface (122, 124) corresponding to a plurality of lighting fixtures (130, 132), wherein each of the lighting fixture is associated with a corresponding physical interface (122, 124), the device is configured to detect a gesture (106) by a user (108), via a mobile device (104), to establish an association with a physical interface. The device (102) is further configured to detect a lighting fixture (130, 132) controllable by the physical interface (122, 124) and generate control signals (120) for the detected lighting fixture, via an orientation sensor, based on movements of the mobile device. The device (102) is also configured to operate the lighting fixture corresponding to the physical interface based on the generated control signals. The movements of the mobile device (104) are similar to the movements involved in the operation of the physical interface (122, 124).

### FIELD OF THE INVENTION

The present invention relates to a technique of lighting control. Specifically, the invention relates to lighting control automation using a mobile device.

### BACKGROUND OF THE INVENTION

Lighting infrastructure in recent years is increasingly becoming smarter. With the integration of wireless control of LED lighting and deployment of various types of sensors such as, but not limited to, occupancy sensor and ambient light sensors, automation of lighting and its operation with optimized energy usage are made possible.

Philips Hue is a consumer connected lighting solution. The Hue system typically comprises a central controller, named a bridge (or hub), wirelessly controllable lighting devices and user interfaces in various forms (light control devices, sensors and mobile device apps). The bridge is connected to the router of the user and communicates to the lighting devices. It can run schedules and home automation rules. In this way, it acts as the intelligence of the system. All user interfaces connect to the bridge in order to actuate the lights.

In the Hue system, mobile device apps are typically used when the user is not close to a light control device. Mobile device apps may also be used to when it is not convenient to use a light control device, as disclosed in US 2016/0342297 A1. US 2016/0342297 A1 discloses that when the user places the smartphone near a control panel, the smartphone picks up functions from the control panel and temporarily impersonates the control panel in the eyes of the house automation system.

The Hue system includes a range of physical accessories that could be used to control lighting, including the Hue dimmer switch, the Hue tap switch and the Hue smart button. The Hue smart button and other hue accessories can only accommodate a limited number of physical controls and have limited means for displaying to the user what behaviors have been assigned to the physical controls. Establishing association of a physical panel controls to control devices via a user mobile is disclosed in WO2013132416 A1.

However, use of sensors extensively in the lighting network can make the infrastructure and installation a costly affair. Commissioning of the lighting infrastructure can be cumbersome with the increased number of light points and the need to integrate the luminaire with the sensors. An another technological trend that is accompanying the smart light networks is the sophistication in the mobile device. A number of sensors are already integrated with the mobile device configured to provide basic calling and messaging services.

Mobile phones with inbuilt sensors are already used in commissioning and controlling the lighting network. Inputs to the mobile is provided via keyboards, touchscreens and such other means. Gestures and the movements of the mobile device are also used to generate control signals. However, there is a need to use the mobile phones in a more easy and natural way to operate the lighting network. Controlling light sources in response to detecting interaction with a light control device by a user is disclosed in WO2021136711 A1. However, user interaction with the light control device is independently defined and may not be intuitively related to the operation of physical interface of the light control device.

### SUMMARY OF THE INVENTION

Embodiments of the present specification relates to a technique of lighting control. Specifically, the invention relates to lighting control automation using a mobile device.

In one aspect of the present specification, a device for lighting automation is disclosed. The device comprises at least one communication interface corresponding to a plurality of lighting fixtures. In one embodiment, the plurality of lighting fixtures comprises a corresponding luminaire. Each of the lighting fixture is associated with a corresponding physical interface. In one embodiment, the physical interface includes one of a slider switch and toggle switch. Although, only two types of switches are listed, the physical interface may also take other forms such as, but not limited to, a rotary switch and other forms of input devices,

The device is configured to establish an association of a physical interface with a mobile device based on a gesture by a user carrying the mobile device. The association is established based on the gesture signals obtained via a mobile device. In one embodiment, the device is configured to detect the physical interface when the mobile device is in its close proximity. In another embodiment, the device is configured to detect the physical interface when the mobile device is pointing towards it. In yet another embodiment, the device is able to receive the information of the physical interface by reading RFID tag fastened on the body of the physical interface via mobile device. The device is further configured to establish an association between the physical interface and the mobile device based on this information.

Further, the device is also configured to detect a lighting fixture controllable by the physical interface. The device is further configured to generate control signals for the detected lighting fixture, via an orientation sensor, based on movements of the mobile device. In one embodiment, the device is configured to receive signals from a mobile which is moved by a user in a pre-specified pattern. The received signals are interpreted as control signals by the device to generate control signals for operating the luminaire. In one embodiment, the pre-specified pattern is a physical movement similar to the movements involved in operating the physical interface associated with the mobile phone. The device is configured to operate the lighting fixture corresponding to the physical interface based on the generated control signals. The invention is characterized in that the movements of the mobile device are similar to the movements involved in the operation of the physical interface.

In another aspect of the present specification, a method for lighting automation is disclosed. The method includes establishing an association of a physical interface among a plurality of physical interfaces corresponding to a plurality of lighting fixtures with a mobile device based on a gesture by a user obtained via a mobile device. In one embodiment, establishing the association between the physical interface and the mobile device includes disposing the mobile device in a close proximity with the physical interface. In another embodiment, establishing the association between the physical interface and the mobile device includes pointing the mobile device in a direction of the physical interface. In yet another embodiment, establishing the association between the physical interface and the mobile device includes receiving information of a RFID tag fastened on the body of the physical interface via the mobile device.

The method further includes detecting a lighting fixture controllable by the physical interface. The method also includes generating control signals for the detected lighting fixture, via an orientation sensor, based on movements of the mobile device. In one embodiment, the control signals may be generated by the mobile device based on the gesture movements by a user. In such an embodiment, the mobile device is configured to exchange data with the physical interface to establish an association between the physical interface and the mobile device. In another embodiment, the control signals are generated by a control device receiving gesture signals from the mobile device. In one embodiment, generating the control signals includes receiving an input via one of sensor devices of the mobile device. It may be noted that the input from the sensor devices is generated by the mobile movements such as a pattern of movement of the mobile device performed by the user.

In a specific instance, the pattern of movement of the mobile device comprises a physical movement of the mobile device. Different types of physical movements of the mobile device generates distinguishable signals from the sensors. These generated signals are provided as inputs for generating the control signals. The method further includes operating the lighting fixture corresponding to the physical interface based on the generated control signals. The method is characterized in that the movements of the mobile device are similar to the movements involved in the operation of the physical interface.

### BRIEF DESCRIPTION OF THE DRAWINGS

The invention will now be further elucidated by means of the schematic non-limiting drawings:

FIG. 1 illustrates a lighting system having a device usable for lighting automation in accordance with the present invention;

FIG. 2 illustrate various sensor devices of the mobile device usable for lighting automation in accordance with the present invention;

FIGS. 3A-3B depict measurements by various sensors of the mobile device usable in lighting automation in accordance with the present invention;

FIGS. 4A-4C depict mobile movements usable for lighting automation in accordance with the present invention; and

FIG. 5 depicts a flow chart representing a method of lighting automation in accordance with the present invention.

### DETAILED DESCRIPTION OF THE EMBODIMENTS

Lighting automation refers to employment of sensors, and the computing power in controlling of lighting without human intervention. The term ‘lighting system’ refers to an illumination arrangement in a facility. The phrase ‘communication interface’ refers to a hardware, a device, a circuit and/or a method used for establishing communication between two devices. The term ‘physical interface’ refers to a physical device disposed on an wall panel used for controlling one or more lighting fixtures in a lighting system. The term ‘sensor’ used herein in a conventional sense to represent transducers that measure a physical quantity and generate a corresponding electrical signal. The terms ‘sensor’ is also used herein to represent components that are used to provide communication protocols such as, but not limited to, GSM, CDMA and bluetooth. The phrase ‘lighting fixture’ is used to refer to an electric device having an electric lamp capable of providing illumination. The lamp may be one or more LED elements. The terms ‘received signal’, ‘movement signal’ and ‘gesture’ are used equivalently and interchangeably and are denoted by reference numeral 106 in the present specification.

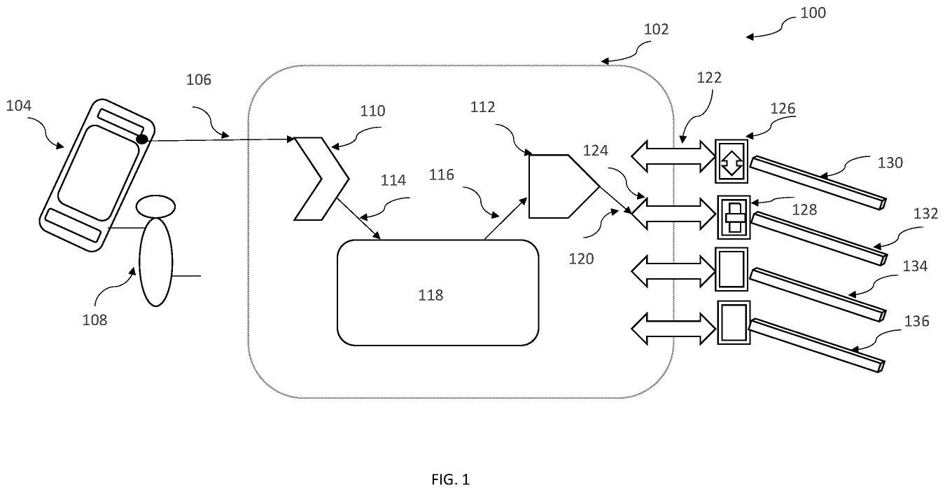

FIG. 1 illustrates a system for lighting automation 100 in accordance with the present invention. The system 100 includes a device 102 usable for enabling lighting automation in accordance with the present invention. The device 102 comprises at least one communication interface 122, 124 corresponding to a plurality of lighting fixtures 130, 132, 134, 136. In one embodiment, the plurality of lighting fixtures 130, 132, 134, 136 comprises a corresponding luminaire (not shown in Fig). Each of the lighting fixture is associated with a corresponding physical interface 126, 128.

In one embodiment, the physical interface 126, 128 includes one of a slider switch and toggle switch. Although, only two types of switches are listed, the physical interface may also take other forms such as, but not limited to, a rotary switch and other forms of input devices, The device 102 is configured to establish an association of a physical interface 126, 128 with a mobile device 104 based on a gesture by a user 108 carrying the mobile device. The association is established based on the gesture signals obtained via the mobile device. In one embodiment, the device 102 is configured to detect the physical interface when the mobile device 104 is in its close proximity. In another embodiment, the device 102 is configured to detect the physical interface when the mobile device 102 is pointing towards it. In yet another embodiment, the device 102 is able to receive the information of RFID tag read fastened on the body of the physical interface via mobile device.

The device is further configured to establish an association between the physical interface and the mobile device based on this information. Further, the device is also configured to detect a lighting fixture controllable by the physical interface. The device 102 is further configured to generate control signals 120 for the detected lighting fixture, via an orientation sensor, based on movements of the mobile device 104. In one embodiment, the device 102 is configured to receive signals 106 from a mobile which is moved by a user in a pre-specified pattern.

The received signals 106 are interpreted as movements of the mobile device 104 representative of gestures of the user 108. The device 102 is further configured to generate control signals 120 for operating the luminaires within the lighting fixtures 130, 132, 134, 136. In one embodiment, the pre-specified pattern is a physical movement similar to the movements involved in operating the physical interface associated with the mobile device 104. The device 102 is configured to operate the lighting fixture corresponding to the physical interface based on the generated control signals 120. The movements of the mobile device as envisaged in the present invention are similar to the movements involved in the operation of the physical interface.

In one embodiment, the device 102 includes a receiver circuitry 110 configured to receive the movement signals 106 generated from sensors of the mobile device 104. The movement signals 106 are representative of gestures made by the user 108. The receiver circuitry 110 is further configured to generate input signals 114 that are used by lighting control unit 118 to generate output signals 116 that are directed towards the chosen lighting fixture via the corresponding communication interface. The signals that are suitable for the chosen communication interface 124 is generated by a transmitter circuitry 112 based on the output signals 116.

The lighting control unit 118 in one embodiment may be a controller, a general purpose processor, or a Digital Signal Processor (DSP). The lighting control unit 118 may receive additional inputs from a user through a control panel or any other input device including a keyboard. The lighting control unit 118 may also include a special purpose or customized hardware modules such as Application Specific Integrated Circuit (ASIC) or Field Programmable Gate Arrays (FPGA). The lighting control unit 118 may include one or more memory modules. These memory modules may also be external to the lighting control unit 118 (not shown in figure). The memory module may be a random access memory (RAM), read only memory (ROM) or any other type of computer readable memory accessible by the lighting control unit 118. The memory medium may be encoded with a program to instruct the lighting control unit 118 to enable a sequence of steps to perform functionalities related to the automation of the lighting.

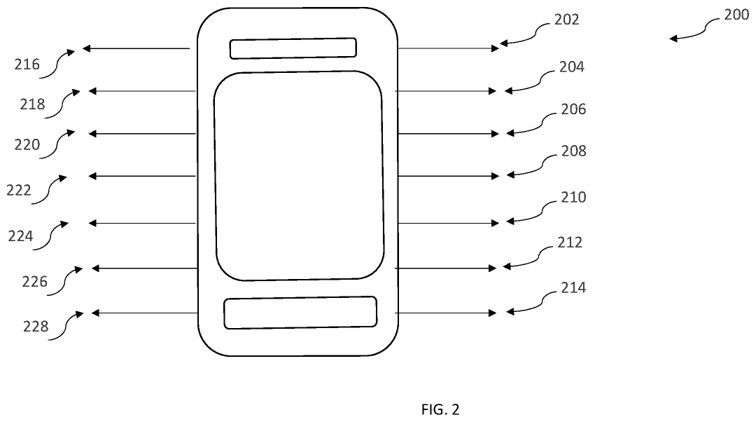

FIG. 2 illustrate various sensor devices 200 of the mobile device usable for lighting automation in accordance with the present invention. The sensor devices 200 are inbuilt into a typical mobile device 230. Not all sensors may be available in all types of mobile devices. However, smart phones may include one or more of sensors illustrated in FIG. 2. In one embodiment, the mobile device 230 includes one or more of an global positioning system (GPS) 202, a wireless communication interface to provide internet connectivity such as wi-fi 204, a wireless communication interface to provide connectivity between two devices over relatively a short distance such as bluetooth 206, a Global System for Mobile communication interface (GSM) 208, and a near field communication interface (NFC) 210. In alternate embodiments, the reference numeral 208 may also represent a code division multiple access interface (CDMA). The mobile device 230 may also include a front camera 212 and a back camera 214. In some of the mobile phones, other sensors such as an accelerometer 216, a gyroscope 218, a magnetometer 220, a barometer 222, a proximity sensor 224, a light sensor 226 and a touch sensor 228 may be present.

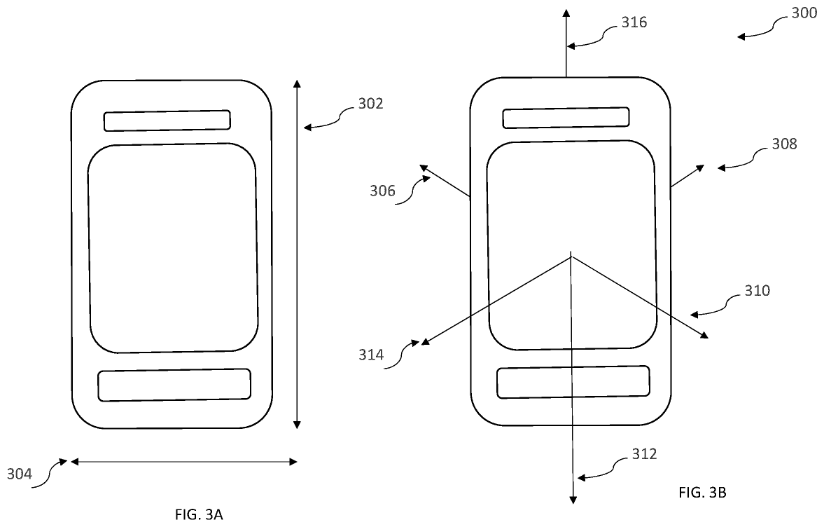

FIGS. 3A-3B depict measurements obtainable by various sensors of the mobile device that are usable in lighting automation in accordance with the present invention. FIG. 3A illustrates measurements by an accelerometer representative of rate of change of velocity of the mobile device. In one embodiment, the accelerometer may be single axis accelerometer configured to measure simple vibrations. In another embodiment, the accelerometer may be a two-axis accelerometer configured to measure acceleration along two perpendicular axes. In yet another embodiment, the accelerometer may be a three-axis accelerometer configured to measure acceleration along three perpendicular axes. The illustrated embodiment of FIG. 3A shows acceleration in a first direction 302 and another acceleration in a second direction 304 perpendicular to the first direction. FIG. 3B illustrates measurements by a gyroscope representative of orientation or angular velocity. The angular orientations are measured with reference to a first axis 306,310, a second axis 308, 314 and a third axis 316, 312. The first axis 306,310, the second axis 308, 314 and the third axis 316, 312 are mutually perpendicular to each other.

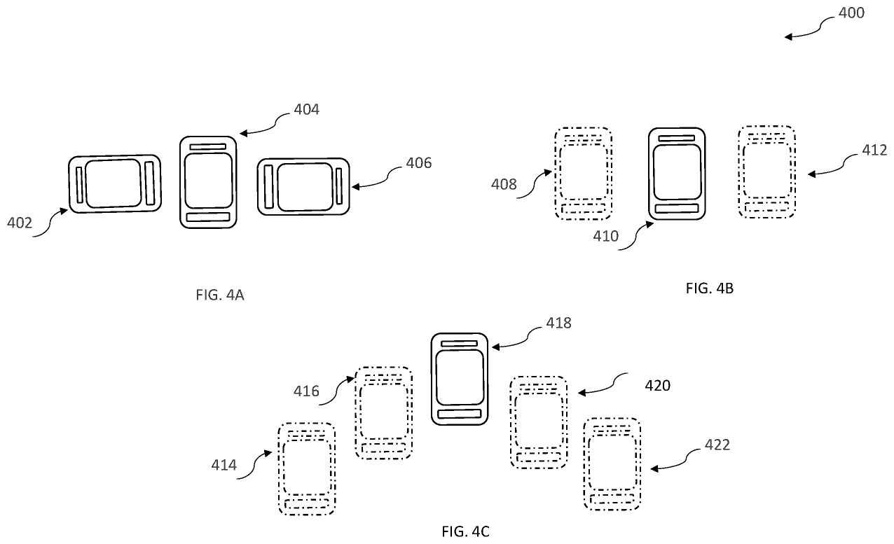

FIG. 4A-4C depict mobile movements 400 usable for lighting automation in accordance with the present invention. FIG. 4A illustrates a tilting movement of the mobile device. A reference numeral 404 in the figure represents the mobile device 104 in an untilted position. The mobile device 104 may be rotated left to get left tilted position 402. The mobile device 104 may be rotated right to get right tilted position 406. The mobile device in sequential positions of 404, 402, 404, 406, 404, 402 makes a tilting movement of the mobile. Alternatively, the mobile device in sequential positions of 404, 406, 404, 402, 404, 406 also provides a tilting movement of the mobile device. The signals of the accelerometer and/or the gyroscope sensors during these positions are usable to detect the tilting gesture made by the user. FIG. 4B illustrates a shifting movement of the mobile device in accordance with one embodiment of the invention. The reference numeral 410 represents untilted position of the mobile device 104. The mobile device 104 in position 408 is left shifted, the mobile device 104 in position 412 is right shifted. The movements of the mobile 104 in sequential positions 410, 408, 410, 412, 410, 408 (or alternatively 410, 412, 410, 408, 410, 412) represents shifting movement of the mobile device. The signals generated by the accelerometer and/or gyroscope during this movement may be analyzed to determine the shifting gesture of the user. FIG. 4C illustrates a movements of the mobile device 104 that constitutes rotational gesture by the user. The mobile device 104 may take positions 414, 416, 418 420, 422 which are points on a approximate circular path. The signals generated by the sensors such as accelerometer and/or the gyroscope may be used by a processing element to determine rotational gesture of the user holding the mobile device.

In one embodiment, one or more of the gestures of the user 108 may be used to change the parameter that would be controlled by subsequent gestures of the user 108. In an alternate embodiment, a particular gesture by a user is intended to generate a particular signal type from a specific sensor of the mobile device 104. Specifically, in one example, a tilting gesture may generate signals from accelerometer and/or gyroscope sensors and may be usable to provide rotary knob functionality. Such a functionality may be used to provide dimming and tuning controls for the luminaire. In another example, a shaking or a rotating gesture by the user 108 may be usable to provide the functionality of selecting a different parameter to control for subsequent gestures by user 108. Specifically, in one embodiment, the shaking or rotation gesture may be used to change the control parameter of the luminaire from dimming to tuning. When the titlting gesture may be configured to alter dimming of a luminaire, shaking gesture followed by tilting gesture would alter the tuning of the luminaire.

In one specific embodiments, the device 102 may establish association between the mobile device and the physical interface by achieving interoperability between the wi-fi and BLE (bluetooth low energy) protocols. While the wi-fi helps in communication between the mobile device 104 and the home wi-fi router, BLE helps in establishing connection between the moving mobile device and the BLE of the luminaire. This technique may be utilized to automate the lighting functionality as well as to provide the functionality of an occupancy sensor within the premises.

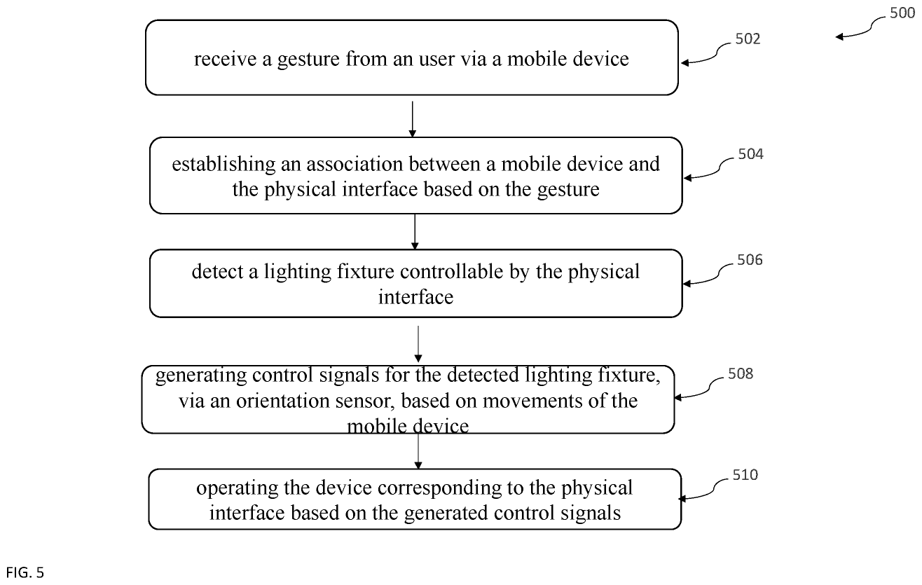

FIG. 5 depicts a flow chart 500 representing a method of lighting automation in accordance with the present invention. The method includes receiving 502 a gesture from an user via a mobile device. The method also includes establishing 504 an association of a physical interface among a plurality of physical interfaces corresponding to a plurality of lighting fixtures with a mobile device based on the gesture. In one embodiment, establishing 504 the association between the physical interface and the mobile device includes disposing the mobile device in a close proximity with the physical interface. In another embodiment, establishing 504 the association between the physical interface and the mobile device includes pointing the mobile device in a direction of the physical interface. In yet another embodiment, establishing 504 the association between the physical interface and the mobile device includes receiving information of a RFID tag fastened on the body of the physical interface via the mobile device.

The method further includes detecting 506 a lighting fixture controllable by the physical interface. The method also includes generating 508 control signals for the detected lighting fixture, via an orientation sensor, based on movements of the mobile device. In one embodiment, the control signals may be generated by the mobile device based on the gesture movements by a user. In such an embodiment, the mobile device is enabled at the time of establishing an association between the physical interface and the mobile device. In another embodiment, the control signals are generated by a control device receiving gesture signals from the mobile device. In one embodiment, generating the control signals includes receiving an input via one of sensor devices of the mobile device. It may be noted that the input from the sensor devices is generated by the mobile movement such as a pattern of movement of the mobile device performed by the user. In a specific instance, the pattern of movement of the mobile device comprises a physical movement similar to the movement observed while operating the physical interface associated with the mobile device.

The method further includes operating 510 the lighting fixture corresponding to the physical interface based on the generated control signals. The method is characterized in that the movements of the mobile device are similar to the movements involved in the operation of the physical interface.

It is to be understood that not necessarily all such objects or advantages described above may be achieved in accordance with any particular embodiment. Thus, for example, those skilled in the art will recognize that the components and configurations of the lighting automation described herein may be embodied or carried out in a manner that achieves or improves one advantage or group of advantages as taught herein without necessarily achieving other objects or advantages as may be taught or suggested in the present specification.

While various embodiments of the device used for lighting automation have been described, it is to be understood that aspects of the specification may include only some of the described embodiments. Accordingly, the specification is not to be seen as limited by the foregoing description but is only limited by the scope of the appended claims.

1. A device for lighting automation, the device comprising at least one communication interface corresponding to a plurality of lighting fixtures, the plurality of lighting fixtures is associated with a corresponding plurality of physical interfaces, the device is configured to:
establish an association between a physical interface among the plurality of physical interfaces and a mobile device based on a gesture provided by a user via the mobile device;
detect a lighting fixture among the plurality of lighting fixtures controllable by the physical interface;
generate control signals for the detected lighting fixture, via an orientation sensor of the mobile device, based on user movements; and
operate the lighting fixture corresponding to the physical interface based on the generated control signals characterized in that movements of the mobile device are similar to movements involved in the operation of the physical interface.

2. The device of claim 1, wherein the plurality of physical interfaces comprises one of a slider, and a toggle switch.

3. The device of claim 1, configured to detect a physical interface among the plurality of physical interfaces, when the mobile device is in a close proximity and prepare performing functionality of the physical interface upon detection.

4. The device of claim 1, configured to detect a physical interface among the plurality of physical interfaces, when the mobile device is pointed in the direction of the physical interface.

5. The device of claim 1, configured to detect a physical interface among the plurality of physical interfaces, by receiving information of an RFID tag fastened on the body of the physical interface via the mobile device.

6. The device of claim 1, configured to generate the control signals when the mobile device is moved in a pre-specified pattern by the user.

7. The device of claim 6, configured to generate the control signals when the pre-specified pattern of movement by the user comprises a physical movement similar to the movements involved in operating the physical interface associated with the mobile device.

8. A method for lighting automation, performed by a device comprising at least one communication interface, a receiver circuitry and a lighting control unit, the method comprising:
establishing an association of a mobile device with a physical interface among a plurality of physical interfaces corresponding to a plurality of lighting fixtures based on a gesture by a user obtained via the mobile device;
detecting a lighting fixture among the plurality of lighting fixtures controllable by the physical interface;
generating control signals for the detected lighting fixture, via an orientation sensor of the mobile device based on user movements; and
operating the lighting fixture corresponding to the physical interface based on the generated control signals, characterized in that movements of the mobile device are similar to movements involved in the operation of the physical interface.

9. The method of claim 8, wherein establishing comprises detecting the physical interface comprising one of a slider switch, a toggle switch, and a dimmer switch.

10. The method of claim 8, wherein establishing the association comprises:
disposing the mobile device in a close proximity with a physical interface; and
enabling mobile device to configure itself to perform functionality of the physical interface.

11. The method of claim 8, wherein establishing the association comprises pointing the mobile device in the direction of the physical interface.

12. The method of claim 8, wherein establishing the association comprises receiving information of an RFID tag fastened on the body of the physical interface via the mobile device.

13. The method of claim 8, wherein the generating the control signal comprises receiving an input via one of sensor devices of the mobile device.

14. The method of claim 13, wherein the input is generated by movements of the mobile device, wherein the movements of the mobile device comprise a pattern of movement of the mobile device performed by the user.

15. The method of claim 13, wherein the input is generated by the pattern of movement of the mobile device, wherein the pattern of the mobile device comprises a physical movement similar to movement observed while operating the physical interface associated with the mobile device
